(19) United States
(12) Patent Application Publication
(10) Pub. No.: US 2005/0028142 A1
(43) Pub. Date: Feb. 3, 2005

(54) Scalable browser

(76) Inventors: Warner Rudolph Theophile Ten Kate, Eindhoven (NL); Ramon Antoine Wiro Clout, Eindhoven (NL); Richard Marcel Pierre Doornbos, Eindhoven (NL)

Correspondence Address: Corporate Patent Counsel;Philips Electronics North America Corporation, P O Box 3001, Briarcliff Manor, NY, 10510, US

(21) Appl. No.: 10/493,805

(22) PCT Filed: Oct. 25, 2002
(86) PCT No.: PCT/IB02/04511

(30) Foreign Application Priority Data
Nov. 1, 2001 (EP) 01204197.6

(51) Int. Cl. G06F 9/44

(52) U.S. Cl. 717/120; 717/107

(57) ABSTRACT

A computer program forming a browser program (200) when executed on a computer (101), wherein: the program is arranged in a browser structure (300) comprised of program components (301, . . . , 306); and the browser program is arranged to process contents arranged in a data structure e.g. Extensible Mark-up Language (XML) comprised of modules enclosed by XML tags. Each program component in the browser structure matches with a respective module in the data structure. The incorporation or removal of certain functionality at the XML document level corresponds to the addition or removal of a piece of software in the architecture. Consequently, resource-constrained devices are enabled to access information e.g. from the Internet, in an interoperable and compatible manner. The resource constraints concern storage capacity and processing power, but also display size etc.

This invention relates to a scalable browser program.

Browser programs are widely known and used as an application program that provides a user interface for viewing and interacting with information distributed on a media such as a local disk, a local network, the Internet etc. The information and the browsers are increasingly being arranged to interface more closely with each other to allow users to interact with various types of information by means of a single application: the browser.

Particularly, for use on the Internet, information is arranged in accordance with a presentation language. Such presentation languages are for instance Hyper Text Mark-up Language (HTML), Dynamic HTML (DHTML), and Extensible Mark-up Language (XML). XML presentation languages consist of predefined XML elements (or tags) that comply with a schema e.g. Document Type Definition (DTD) or XML Schema.

Modularization is the act of splitting up such a set of elements from one language into subsets, or modules. XHTML and SMIL are examples where such a modularization has been defined. It is also possible to define an element set, with presentation semantics and elements that can be combined (or embedded) with other elements, without being a complete language on its own. MathML, Ruby and XForms are examples in that category.

Once the modules are available, they can be combined into profiles. A profile is a language, in that it provides a set of elements providing a coherent and complete set of semantics needed by the user. Obvious profiles are the languages from which modules were derived, such as the XHTML and SMIL languages. A profile can be implemented by an application.

The mechanisms of modularization and profiling are based on the extensibility property of XML. XML specifies how elements can be combined in a document.

Profiling can also be across original languages domains. Examples are the XHTML+SMIL profile and SMIL-Animation for the purpose of animating SVG.

Thus there are great opportunities for providing presentation information to a browser. In terms of data communication the information to be presented and information describing the presentation are communicated via e.g. the widely used TCP/IP protocol.

In order to present information in accordance with the above, the browser program must support a presentation language. This includes parsing information, and rendering contents in the information in accordance with rendering rules of the language. The languages are becoming more and more advanced and involve complex implementation of rendering rules in the browser. This requires extensive use of working memory, storage capacity, and processing power. Especially, when more presentation languages are to be supported by the browser extensive system resources are needed. Today there is demand for browsers in small-sized/portable devices such as mobile telephones, Portable Digital Assistants (PDA's), etc. to view an increasing load of information provided to these devices more clearly. Since such devices suffer from relatively small system resources it is also necessary to lower system resource requirements.

EP-A2-1003101 discloses an application kernel used in combination with user interface components and data components. The kernel resides at a client side and is able to download components as needed from a server. This is a dynamic process controlled by the kernel and executed in communication with the server.

However, the above prior art method involves the problem that it is only involved with downloading components needed for processing data which otherwise (i.e. before the download) could not be processed. This prior art can be considered as being complementary to the present invention.

The above and other problems are solved by a computer program forming a browser program when executed on a computer, wherein: the program is arranged in a browser structure comprised of program components; the browser program is arranged to process contents arranged in a data structure comprised of modules; and wherein each program component in the browser structure matches with a respective module in the data structure.

Thereby, the computer program and the functionality it disposes can be scaled with present data. A further advantage is that similar types of modules (e.g. defined by XML constructs), from different sources, can be reused in different profiles—or applications.

Consequently, resource-constrained devices are enabled to access information e.g. from the Internet, in an interoperable and compatible manner. The resource constraints concern storage capacity and processing power, but also display size etc. Handheld devices, such as mobile phones, form a major class in this area.

The browser program to be run on the resource-constrained devices can thus be arranged to conform a profile of a customized presentation language.

The invention's objective is to design the software structure for performing the XML document rendition in such a manner that the functions represented by the XML modules also appear in a modularised manner in the structure. The incorporation or removal of certain functionality at the XML document level corresponds to the addition or removal of a piece of software in the architecture. This can be realised by means of component technology.

In component technology one designs the pieces of software with well-defined interdependencies. Examples of component technologies are COM, Darwin and Koala. The components (program components) are characterized in being encapsulated pieces of software that can communicate with their environment via interfaces. The interfaces implement methods for either input or for output. The input corresponds to the needs by the component to perform its function correctly; the output corresponds to the result of that function.

The components can be combined in a structure by connecting output and input interfaces. The connection can be realized at compile time or at run time. A constellation of components can be identified as a component by itself, or vice versa a component can possibly by split up in sub-components.

Preferably, each of the program components is arranged to receive content from the respective module and is supplied with functions arranged to operate on content from the respective module.

In an expedient embodiment the computer program has a parser for extracting content from respective modules and providing content of a respective module to a program component matching the respective module.

When the size and functionality of a program component is scaled with the size of available resources of a system to run the computer program, the scalability involves individual components. This allows for adapting the browser program to devices with only very limited resources.

When the data structure is an XML data structure with modules defined by XML elements, the matching can be made very simple.

The computer program can be arranged to download program components and integrate them as a portion of the browser. Thereby, the program can adapt or be adapted to changes over time—for instance to take advantage of modified and/or additional program components.

When the data structure is split by the modules and forwarded to browsers distributed on multiple devices, the browsers can be tailored to specific devices. This is particularly expedient when the devices are able to communicate mutually.

The program can be arranged to dispose different capabilities in the form of profiles by loading into the structure a set of components corresponding to a selected profile. Thereby, the browser scales with requirements of a selected profile. The structural architecture of the program allows degree of adaptability to a selected profile. This in turn allows for very efficient memory usage.

The invention will be explained more fully below in connection with preferred embodiments and with reference to the drawings, in which:

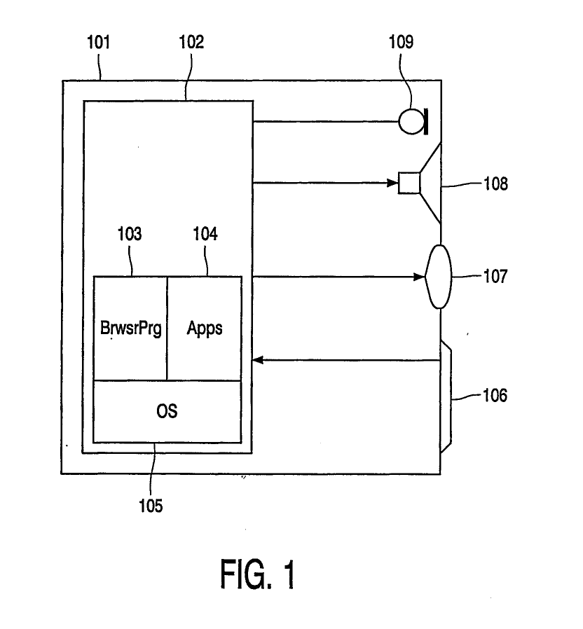

FIG. 1 shows a browser in a system;

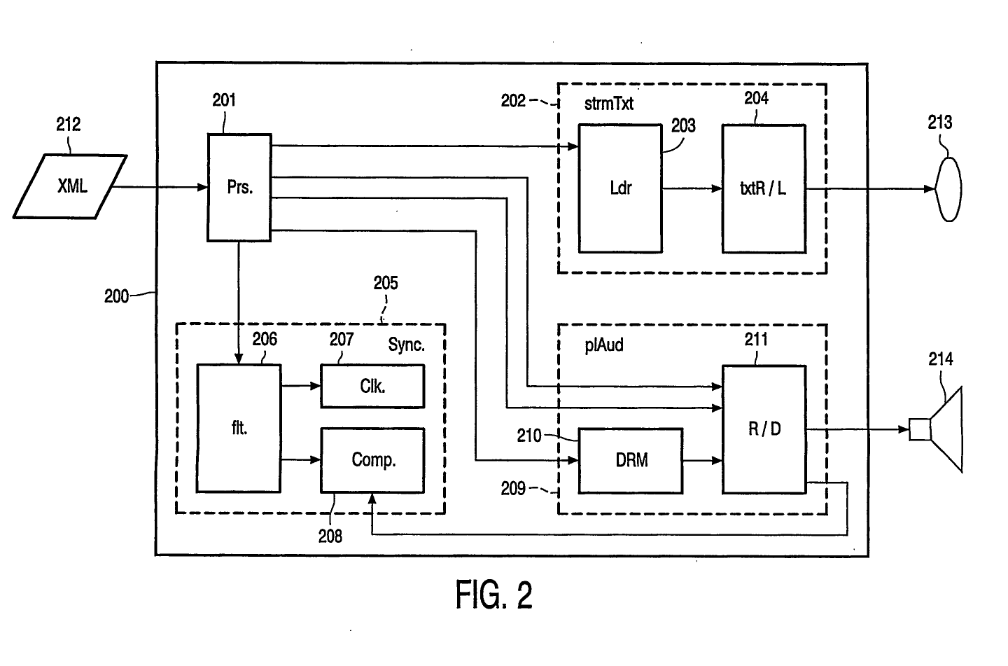

FIG. 2 shows a first structure of a browser; and

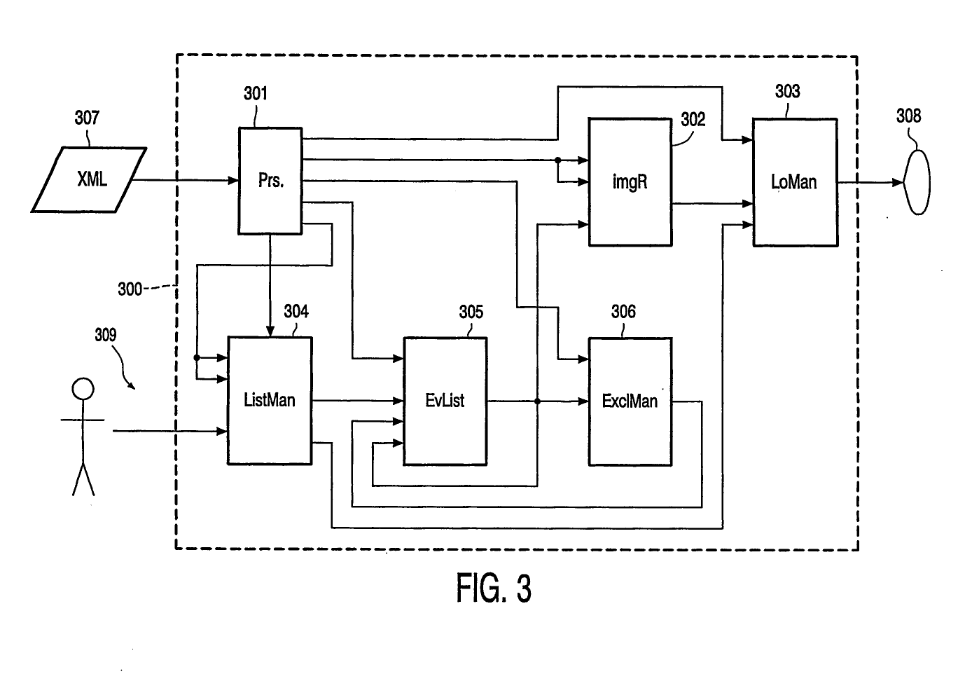

FIG. 3 shows a second structure of a browser.

FIG. 1 shows a browser in a system. The system 101 can be a mobile telephone, a Personal Digital Assistant (PDA), general purpose computer etc. Generally, the term computer as used herein comprises all types of consumer electronics such as TV sets, radios, set-top boxes etc.

The system comprises a computer unit 102 capable of running an Operating System program (OS) 105, application programs (Apps) 104, and a browser program (BrwsrPrg) (103). The term application programs (Apps)′ covers programs that are run by the computer system 102 for different purposes. Such application program can be E-Mail applications, calendar applications, etc

The system comprises interface means such as a microphone 109, a loudspeaker 108, a display 107, and keyboard 106. Moreover, the interface means may comprise a computer mouse (not shown).

FIG. 2 shows a first structure of a browser program. The browser program 200 is comprised of program components to operate on separate content portions in an input file or stream of data. The browser program 200 is arranged to process contents arranged in a data structure comprised of modules. Preferably the data structure is in accordance with the Extensible Mark-up Language (XML), wherein in a module is defined as a node and sub-nodes, if any, in a tree-representation of the XML structure. A node or sub-node comprise one or more elements containing content and is enclosed by start-tags and end-tags. In the Figure an input file 212 (XML) is received by a parser component (Prs) 201 of the browser program 200. The parser component 201 is arranged to extract contents from respective modules and to provide content of a respective module (i.e. a content portion) to a program component matching the respective module.

A first component 202 denoted streamedText (strmTxt) comprises a subcomponent 203 denoted Loader (Ldr) and a subcomponent 204 denoted ‘Text Rendition and Layout’ (txtR/L). Input to the first component is supplied from the Parser 201 and from a second component 205 denoted Synchronisation (Sync). Output from the component is supplied to display means 213 via a driver (not shown).

The second component 205 comprises a subcomponent 206 denoted Filter (flt), a subcomponent 207 denoted Clock (Clk), and a subcomponent 208 denoted Comparator (Comp). Input to this component is provided by the Parser 201.

A third component 209 denoted playAudio (plAud) comprises a subcomponent 210 denoted DRM and a subcomponent 211 denoted ‘Render and Decode’ (R/D). Output from the third component is supplied to loudspeaker means 214 via a driver (not shown).

As will be shown in the following example I these program components, in the browser structure, matches with a respective module in the data structure.

Example I is explained in terms of profiles. It is recalled that a profile is a configured service providing a coherent and complete set of functions for complying with a user's demands while obeying system capabilities. Generally, it should be mentioned that the below terms are assumed to be well known by a person skilled in the art. However, more information about the semantic and elements used in the examples can be found at www.w3.org/AudioVidio where SMIL (Synchronized Multimedia Integration Language) is explained.

### EXAMPLE I

### Synchronization

In this example four profiles are exemplified:
Profile 1A—Presentation of streamed text.
Profile 1B—Presentation of audio.
Profile 1C—Presentation of both together.
Profile 1D—synchronized presentation.

Profile 1A—Presentation of streamed text: There is one XML module, called ‘StreamedText’ (capital S):

Module: StreamedText

<textstream>
<page time=“0”>Here is the text to be displayed at time “0”</page>
<page time=“1”>Here is the text to be displayed at time “1”</page>
<page time=“2”>Here is the text to be displayed at time “2”</page>
...
<page time=“N-1”>Here is the text to be displayed at time “N-1”</page>
</textstream>

The ‘StreamedText’ module consists of two elements, <textstream> and <page>. The element <textstream> wraps the module ‘StreamedText’, and the element <page> delimits each string of text to be presented one after the other. The element <text> has an attribute denoted ‘time’ and indicating when a new <page> is to replace a previous one. It should be noted that other elements and attributes are conceivable, e.g. for determining a display position, duration of display etc.

With a view to FIG. 1 the program components are specified in terms of their input and output, which in turn constitutes the interface of the components:

TABLE 1
streamedText component.

| name | Loader |
|---|---|
| input | content of all <page> elements |
| input | trigger (received from Clock) |
| output | single text string, i.e. the content of one <page> |
| name | Text Rendition And Layout |
| input | text string (received from Loader) |
| output | screen image of the formatted text |
| name | Clock |
| input | all time values of the <page>s (received from Parser) |
| output | trigger (when time value passes - the component generates |
| | the clock ticks itself) |

The Loader and the Text Rendition And Layout components can be combined in a single component, streamedText (lower case s).

Profile 1B—Presentation of audio: There is one XML module, called PlayAudio (capital P):

Module: PlayAudio

<audio src=“rtsp://examplecast.net/evergreens/beatles/
yesterday.mp3” type=“mp3” drm=“free”/>

The PlayAudio module consists of one element, <audio>. It references an audio file on the internet, indicated by its attribute “src”. The file is of type “mp3”, and it is free for playback according to the attribute “drm”.

The program components are specified in table 2 below:

TABLE 2
playAudio component.

| name | DRM |
|---|---|
| input | digital rights value (received from Parser) |
| Output | enable |
| name | Render And Decode |
| input | audio file address (received from Parser) |
| input | coding type (received from Parser) |
| input | enable (received from DRM) |
| output | (fetched and decoded) audio signal |

The DRM and the ‘Render And Decode’ components can be combined in a single component, playAudio (lower case p).

Profile 1C—Presentation of both together: The profile takes the previous two XML modules, StreamedText and PlayAudio, together:

Module: merged module.

<par>
<textstream>

<page time=“0”>Here is line 1 from the song</page>
<page time=“1”>Here is line 2 from the song</page>
<page time=“2”>Here is line 3 from the song</page>
...
<page time=“N-1”>Here is line N from the song </page>

</textstream>
<audio src=“rtsp://examplecast.net/evergreens/beatles/
yesterday.mp3” type=“mp3” drm=“free”/>
</par>

In fact the profile consists of three modules, as it also includes the element <par> to indicate that its two children, <textstream> and <audio>, are to be presented simultaneously. The element is parsed, but is not processed further in this profile. The audio is reproduced while at the same time the lines from the song are displayed on a screen. The two proceed unsynchronized.

The program components are specified in table 3 below:

TABLE 3
component.

| name | Loader |
|---|---|
| input | content of all <page> elements |
| input | trigger (received from Clock) |
| output | single text string, i.e. the content of one <page> |
| name | Text Rendition And Layout |
| input | text string (received from Loader) |
| output | screen image of the formatted text |
| name | clock |
| input | all time values of the <page>s (received from parser) |
| output | trigger (when time value passes; the component generates |
| | the clock ticks itself) |
| name | DRM |
| input | digital rights value (received from Parser) |
| Output | enable |
| name | Render And Decode |
| input | audio file address (received from Parser) |
| input | coding type (received from Parser) |
| input | enable (received from DRM) |
| output | (fetched and decoded) audio signal |

Profile 1D—Synchronized presentation of both together: The profile extends the previous profile with synchronization functionality, or, vice versa, the previous profiles are subsets from this one:

Module: complete module.

<par>
<textstream>
<page time=“yday.marker(1)”>Here is line 1 from the song</page>
<page time=“yday.marker(2)”>Here is line 2 from the song</page>
<page time=“yday.marker(3)”>Here is line 3 from the song</page>
...
<page time=“yday.marker(N)”>Here is line N from the song</page>
</textstream>
<audio src=“rtsp://examplecast.net/evergreens/beatles/ yesterday.mp3”
type=“mp3” drm=“free” id=“yday”/>
</par>

This profile consists of the same modules as in example 1C, however extended with a fourth module, called MediaMarkerTiming (alike the module with the same name in the SMIL20 specification), that includes for media marker and synchronization functionality. The audio is reproduced while at the same time the lines from the song are displayed on a screen. Now, the two proceed synchronized.

The program components are specified in table 4 below:

TABLE 4
component.

| name | Loader |
|---|---|
| input | content of all <page> elements received from parser |
| input | trigger (received from Synchronization) |
| output | single text string, i.e. the content of one <page> |
| name | Text Rendition And Layout |
| input | text string (received from Loader) |
| output | screen image of formatted text |
| name | Clock |
| input | all time values that are clock values (received from Filter) |
| output | trigger (when time value passes —the component generates |
| | the clock ticks itself) |
| name | DRM |
| input | digital rights value (received from Parser) |
| Output | enable |
| name | Render And Decode |
| input | audio file address (received from Parser) |
| input | coding type (received from Parser |
| input | enable (received from DRM) |
| output | (fetched and decoded) audio signal |
| output | markers |
| comment | This output is added by the addition of the |
| | MediaMarkerTiming. One can think of this output as |
| | generated by a subcomponent of this Renderer And |
| | Decoder component. (The subcomponent is not shown in |
| | the Figure.) In that perspective this subcomponent was an |
| | “empty” one in the former examples (and the markers |
| | output of this Renderer And Decoder component |
| | would have been a dangling one). |
| name | Synchronisation |
| input | all time values of the <page>s (received from Parser) |
| input | markers (received from Render And Decoder) |
| output | trigger (when either Clock or Comparator fires) |
| comment | The Synchronization component wraps the Clock |
| | component. The Clock's input is connected to the |
| | Synchronization's input, via a filter subcomponent that |
| | filters through the appropriate time-values. The Clock's |
| | output is connected to the Synchronization's output. This |
| | Synchronization component also contains a third |
| | subcomponent (next to Clock and Filter), Comparator, |
| | that performs the comparison between markers and |
| | time-values, filtered for being markers. This third |
| | component's output is connected to the Synchronization's |
| | output. To explain the filtering a bit further. Although the |
| | XML document in this example 1D only contains <page |
| | time=“yday.marker(.)”>declarations, it could also |
| | have contained <page time=“.”>declarations. |
| | The Filter subcomponent separates these two |
| | to the two other subcomponents, Clock and Comparator. |
| name | Filter |
| input | all time values of the <page>s (received from Parser) |
| output | all time values that are clock values |
| output | all time values that are marker values |
| name | Comparator |
| input | all time values that are marker values (received from Filter) |
| input | markers (received from Render And Decoder) |
| output | trigger (when marker value matches time value) |

The relation between XML modules and program components in example I is as follows:

TABLE 5

| XML module | SW component |
|---|---|
| StreamedText | streamedText and Clock |
| PlayAudio | playAudio |
| MediaMarkerTiming | Comparator and subcomponent in |
| | Renderer And Decoder |
| StreamedText + MediaMarkerTiming | Filter |

The Filter component is implied by the presence of two timing types: StreamedText and MediaMarkerTiming.

Note that the association of components with modules can depend on the hierarchy in the profiles. Clock is associated with StreamedText; Filter and the wrapper Synchronization are introduced when both forms of timing enter the profile. The association of these timing modules relates to the hierarchy in the timing. For example, a profile is conceivable that does not support the clock time-values. It would imply the replacement of the Clock component by an empty component (and Filter can be emptied). The Clock component is not associated in a hard way with the StreamedText module.

FIG. 3 show& a second structure of a browser. In the Figure an input file 307 (XML) is received by a parser component 301 (Prs) of the browser program 300. The parser component 301 is arranged to extract contents from respective modules and to provide content of a respective module (i.e. a content portion) to a program component matching the respective module.

A component 302 denoted ‘Image Render’ (imgR) receives input from the Parser 301 and provides output to a component denoted ‘Layout Manager’ 303 (LoMan) which in turn provides an output to a display 308 via a driver (not shown). The ‘Layout Manager’ 303 receives additional inputs from the Parser 301 and a component 304 denoted ‘List Manager’ (ListMan).

The ‘List Manager’ component is responsible for receiving events raised by a user operating a user interface. The events may be so-called ‘on-click’ events, on ‘mouse-move’ events, ‘double-click’ events etc. In addition to supplying an output to the ‘Layout Manager’, an output is supplied to the ‘Event Listener’ component 305 (EvList).

A component ‘Excl Manager’ 306 (Exclman) receives input from the Parser and the ‘Event Listener’ and supplies an output to the ‘Event Listener’.

As will be shown in the following example II these program components, in the browser structure, matches with a respective module in the data structure.

### EXAMPLE II

### Layout

In this example three profiles are exemplified:
Profile 2A—Presentation of image gallery without layout.
Profile 2B—Addition of UI-list with layout.
Profile 2C—Addition of UI-list for small screen (no layout).

Profile 2A—Presentation of image gallery without layout: There are a couple of XML modules: ExclTimeContainers, EventTiming and MultiArcTiming alike those from SMIL20, and Image alike the one from XHTML:

Module

<excl>
<img id=“pict1” src=“picture1.png” begin=“0; pictN.click”/>
<img id=“pict2” src=“picture2.png” begin=“pict1.click”/>
...
<img id=“pictN” src=“pictureN.png” begin=“pictN-1.click”/>
</excl>

The <excl> element from the ExclTimeContainers module contains <img> elements from the Image module. The <excl> element has the semantics that only one of its children can be presented at a time. If an element becomes active the current one becomes deactivated. The begin attributes from the EventTiming module specify when the corresponding <img> element must be shown.

The begin attribute of the first <img> has two values, allowed by the MultiArcTiming module. It realizes initiation of the <excl>.

A new <img> is shown after receiving a ‘click’ event from its previous <img>. The ‘click’ event is initiated by some user action and brought into the system in a platform dependent way.

Cyclic presentation of the images results.

The program components:

TABLE 6
Components for presentation of image gallery without layout.

| name | ImageRender |
|---|---|
| input | all <img> ids (received from Parser) |
| input | element id of <img> to be displayed (received |
| | from EventListener) |
| comment | The component should receive a picture file address |
| | from another component that would provide that file address |
| | given the element id, the transformation table being loaded |
| | from the Parser. For simplicity, this is left away. |
| output | screen image of rendered picture |
| name | EventListener |
| input | registration list (received from Parser) |
| input | user ‘click’ event (received from platform) |
| input | activate registrant (received from EventListener) |
| input | de-activate registrant (received from ExclManager) |
| output | activate trigger labeled with element id |
| name | ExclManager |
| input | all <img> element ids (received from Parser) |
| input | activate trigger labeled with element id (received |
| | from EventListener) |
| output | deactivate trigger labeled with element id |

Profile 2B—Addition of UI-list with layout: The profile extends the previous profile with a List module and a Layout module, of which the latter is comparable to the SMIL ‘Basic Layout’ module:

Module

<gallery>
<list top=“0” left=“0” width=“50%” height=“100%”>

<item id=“item1”>Picture 1</item>
<item id=“item2”>Picture 2</item>

...

<item id=“itemN”>Picture N</item>

</list>
<excl top=“0” left=“50%” width=“50%” height=“100%”>

<img id=“pict1” src=“picture1.png” begin=“item1.click”/>
<img id=“pict2” src=“picture2.png” begin=“item2.click”/>
...
<img id=“pictN” src=“pictureN.png” begin=“itemN.click”/>

</excl>
</gallery>

The Layout module adds the top, left, width and height attributes (it differs from the SMIL20 BasicLayout module in the way it is adding the attributes); the List module adds the <list> and <item> elements, which declare a UI list widget and its fields, respectively. The list is to be displayed at the left half, the pictures at the right half of the screen. The UI rendition of the <list> might be scrollable in one or another way. The <item> element contains a text string that is to be displayed in the fields of the list. Upon clicking a field an event is raised associated with the corresponding <item> element. (The <gallery> element is needed for XML well-formedness purposes, but is not relevant for this discussion.)

The program components:

TABLE 7
Components for a UI-list with layout.

| name | ListManager |
|---|---|
| input | all <item> element ids (received from Parser) |
| input | screen size (received from parser) |
| input | user ‘click’ event labeled with field id, e.g. its coordinates |
| | (received from platform) |
| output | screen image of rendered list |
| output | event notification labeled with element id |
| name | ImageRenderer |
| input | all <img> ids (received from Parser) |
| input | element id of <img> to be displayed (received from |
| | EventListener) |
| input | all image sizes (received from Parser) |
| output | screen image of rendered picture |
| name | LayoutManager |
| input | screen images (received from both Renderers) |
| input | screen images are labeled with Renderer id |
| input | position, size and z-order of screen images (received |
| | from Parser) |
| output | screen image of full screen |
| name | EventListener |
| input | registration list (received from Parser) |
| input | event notification labeled with event source id (received |
| | form list manager) |
| input | activate registrant (received from EventListener) |
| input | de-activate registrant (received from ExclManager) |
| output | activate trigger labeled with element id |
| name | ExclManager |
| input | all <img> element ids (received from Parser) |
| input | activate trigger labeled with element id (received from |
| | EventListener) |
| output | deactivate trigger labeled with element id |

Profile 2C—Addition of UI-list for small screen (no layout): The profile is the same as the previous profile, however, the Layout module is not supported; the Layout syntax can be parsed and validated, but the declared behaviour is not performed:

Module

<gallery>

<list top=“0” left=“0” width=“50%” height=“100%”
begin=“0;excl.click”>

<item id=“item1”>Picture 1</item>
<item id=“item2”>Picture 2</item>
...
<item id=“itemN”>Picture N</item>

</list>
<excl id=“excl” top=“0” left=“50%” width=“50%” height=“100%”>

<img id=“pict1” src=“picture1.png” begin=“item1.click”/>
<img id=“pict2” src=“picture2.png” begin=“item2.click”/>
...
<img id=“pictN” src=“pictureN.png” begin=“itemN.click”/>

</excl>

</gallery>

Either the list or a selected picture is shown. A picture is selected by clicking on the list. Clicking a picture will always lead to showing the list. (More sophisticated schemes are conceivable such that not always the list is shown in between pictures, e.g. by using double-clicking and right-clicking, or as shown in the Example 3B below, etc. This not relevant for this discussion.)

The program components:

TABLE 8
Components for UI list for small screen (no layout).

| name | Listmanager |
|---|---|
| input | all <item> element ids (received from Parser) |
| input | screen size (received from Parser) |
| input | user ‘click’ event labeled with field id, e.g. its coordinates |
| | (received from platform) |
| output | screen image of rendered list |
| output | event notification labeled with element id |
| name | ImageRenderer |
| input | all <img> ids (received from Parser) |
| input | element id (received from EventListener) |
| input | all image sizes (received from Parser) |
| output | screen image of rendered picture |
| name | LayoutManager |
| input | screen images (received from both Renderers; screen images |
| | are labeled with render id) |
| input | position, size, and z-order of screen images (received from |
| | Parser) |
| output | screen image of full screen |
| name | EventListener |
| input | registration list (received from Parser) |
| input | event notification labeled with event source id (received from |
| | ListManager) |
| input | activate registrant (received from EventListener) |
| input | de-activate registrant (received from ExclManager |
| output | activate trigger labeled with element id |
| name | ExclManager |
| input | all <img> element ids (received from Parser) |
| input | activate trigger labeled with element id (received from |
| | EventListener) |
| output | deactivate trigger labeled with element id |

The ‘Layout Manager’ is heavily reduced. It performs the task replacing the screen images with its last received input. There will be one rendition, i.e. one element, visible at a time.

It is recalled, again, that the example is intended to show the invention in simple manners. A more sophisticated domain analysis will lead other ways of designing the components. For instance, the components as shown here might be split in subcomponents, where they are grouped in different ways depending on the profile. It remains, however, that an XML module associate with these subcomponents. More precisely, in this example 2C, the separation of user clicks would not be performed by the ListManager; it rather relates to an additional component managing and dispatching the events. As said, this is not detailed in the example. A similar remark concerns the clearance of layout space when an <img> is deactivated.

The relation between XML modules and SW components is as follows from table 9:

TABLE 9

| XML module | SW component |
|---|---|
| Image | ‘Image Renderer’ |
| EventTiming + MultiArcTiming | ‘Event Listener’ |
| ExclTimeContainers | ‘Excl Manager’ |
| List | ‘List Manager’ |
| Layout | ‘Layout Manager’ |

### EXAMPLE III

### Multiple Devices

In this example two profiles are exemplified:
Profile 3A—Device for text and device for Audio.
Profile 3B—Device for image presentation and device for managing a list.

This example discusses another form of application of the scalability property. In the first two examples the scalability related to expanding the capabilities of the client device. In this example, we take the previous two scenarios, but we combine two devices of complementary capability. The two devices are loaded with the same XML document. Possibly they are interconnected, such that they can synchronize their operation. The first device is capable of presenting one part of the document, the second device of presenting the other part.

Since the devices are loaded with the same XML document, it is assumed that the document allows its partial presentation in case the client is only capable of doing so. Otherwise a pre-processor (proxy, possibly hosted at one of the devices) is required that splits the document into two.

The fetching and loading of the document to the two devices also requires some type of communication between them. In case of synchronization between the two devices during the presentation of the document, there is also the need for hosting that function.

The SMIL20 Basic specification is an example of how the same document can be loaded to clients of different capability. It uses, i.e., an attribute called systemRequired to declare the need for support of a certain module. The attribute is part of the module called BasicContentControl. It has the semantics that the rendition of the sub-tree rooting at the element at which it is called may only be performed if its associated capability is supported. Otherwise the sub-tree must be skipped, while the client may proceed rendering the remainder of the document. In the examples below we copy from this module. Note, that it implies a corresponding program component to perform the capability checking.

### EXAMPLE 3A

### Device for Text and Device for Audio

There are two devices, one able to present streamed text according to Profile 1A, the other able to present audio according to Profile 1B. The two devices are both loaded with the XML document from Profile 1C, however modified with the systemRequired attribute:

Module

<par>
<textstream systemRequired=“streamedText”>

<page time=“0”>Here is line 1 from the song</page>
<page time=“1”>Here is line 2 from the song</page>
<page time=“2”>Here is line 3 from the song</page>
...
<page time=“N-1”>Here is line N from the song</page>

</textstream>
<audio src=“rtsp://examplecast.net/evergreens/beatles/ yesterday.mp3”
type=“mp3” drm=“free” systemRequired=“playAudio”/>
</par>

The first device will present the streamed text and the second will reproduce the audio. If both devices can be synchronized, the Synchronization module, shown in FIG. 2 and described in Profile 1D, has to be hosted to control the synchronization between the two devices. This can be in the proxy, or in one of the two devices. If the author of the XML document wishes to require the synchronization, a systemRequired call for the MediaMarkerTiming is needed at the <par> element.

### EXAMPLE 3B

### Device for Image Presentation and Device for Managing a List

There are two devices, one able to display pictures according to Profile 2A, the other able to present the list of the picture enabling a user to navigate through the pictures. The list is according to the one in Profiles 2B and 2C. The two devices are connected to each other, such that the “list” device can signal choices to the “picture” display. The two devices are both loaded with the XML document from Profile 2C, however modified with the systemRequired attribute and with additional event declarations on the <img> according to Profile 2A:

Module

<gallery>
<list begin=“0;excl.click” systemRequired=“List”>

<item id=“item1”>Picture 1</item>
<item id=“item2”>Picture 2</item>
...
<item id=“itemN”>Picture N</item>

</list>
<excl id=“excl” systemRequired=“ExclTimeContainers+
EventTiming+MultiArcTiming+Image”>

<img id=“pict1” src=“picture1.png” begin=“0; item1.click;
pictN.click”/>
<img id=“pict2” src=“picture2.png” begin=“item2.click;
pict1.click”/>
...
<img id=“pictN” src=“pictureN.png” begin=“itemN.click;
pictN-1.click”/>

</excl>
</gallery>

The first device will present the pictures; the user can scroll through them by ‘clicking’ the picture (the clicking can be in the form of hitting a knob-button on the display device). It supports the components as described in Profile 2A. The second device will present the list of pictures. It supports the components that Profile 2C adds to Profile 2A, noteworthy the ListManager. The second device communicates with the first device to notify the events.

It is also conceivable that the first device performs as in Profile 2C, i.e. that it includes the ListManager. The second device then provides for remote control of the first device. Instead of navigating a list of images, one could think of navigating TV programs, where the list represents the EPG (electronic Program Guide). The TV screen remains presenting the TV programs, while on the remote control the program guide can be inspected. Another scenario is where a TV program consists of multiple (camera) views. Instead of presenting the navigation fields together with the selected view on the same screen, a peripheral device can take over that part of the presentation. The program maker designs the XML document that describes the complete program including navigation through the views. The TV is able to present that all, alike Profile 2C, while extending the TV with a dedicated remote for the UI components and loading that with the same XML document from the program maker, enables the separation of UI and program display (aside from the comfort of remote usage). This assumes the XML document contains information like the systemRequired attribute. Note that the program can also be employed on TV sets that do not support the navigation at all, along the lines of scenario 2A.

It may be useful to stress that “components” and “structure” are concepts that are used at the software design phase. They provide an abstraction level above the actual program code that instructs their functionality. A compiler is assumed to create the actual code and to optimise that for performance criteria such as code size.

Components can also be replaced by other components, as long as they full-fill the same input/output relations. For example, a certain function can be removed from the structure by replacing the corresponding component through an empty component that satisfies the input/output relations. It takes the output from the other components to which its input is connected and either discards that or passes it through to its own output. The information becoming available at the output can also be generated by the component, e.g. being a fixed constant. It is also possible that the received input is slightly modified before being supplied to the output. This all depends on the precise function of the component and its role in the total structure. A way of thinking of the replacing “empty” component is that of a glue layer (in the form of a simple component) between the components performing the functions that have remained.

XML modules (or a set of XML modules) representing functionality at the language level are associated with components (or a set of components) at the program or software level that implement the function. The profiling at the language level corresponds to the (re)configuring/instantiating of the components in the structure. There is one unified structure, however implementations on devices implement only parts of it, such as to scale with the required functionality profile. The parts that are implemented contain the subset of components that correspond with the XML modules forming the profile at the XML presentation language level.

Examples of XML functionality modules include:
Timing for synchronization
Timing for interaction and other events
Timing for animation
UI; widgets (buttons, sliders)
UI; user input (XForms)
UI; speech (input and/or output)
Layout for text (HTML)
Layout for text styling (CSS)
Layout for media (audio/video rendition)
Layout for graphics
Layout for streamed text (close captioning)
Layout for digital rights and key management (encryption)
Layout for mathematical formulas (MathML)

All designs in this document, such as the used XML mark-up, are by way of example. There is not necessarily a one-to-one (semantic) map with existing XML having the same syntax and grammar. Neither is there a suggestion to provide good design of the mark-up. Likewise, the program components are named by way of example, but do not imply optimal design in terms of performance metrics such as memory consumption or functional operation.

In order to keep the number of components low, components are grouped into larger components where that doesn't affect the example. Trivial components, not relevant to the examples are left out.

1. A computer program product forming a browser program (103; 200; 300) when executed on a computer (101), wherein:
the program is arranged in a browser structure (200; 300) comprised of program components (201, . . . , 211; 301, . . . , 306);
the browser program is arranged to process contents arranged in a data structure comprised of modules; and
each program component in the browser structure matches with a respective module in the data structure.

2. A computer program product according to claim 1 wherein each of the program components is arranged to receive content from the respective module and is supplied with functions arranged to operate on content from the respective module.

3. A computer program product according to claim 1 wherein the computer program has a parser (201; 301) for extracting content from respective modules and providing content of a respective module to a program component (202, . . . , 211; 302, . . . , 306) matching the respective module.

4. A computer program product according to claim 1 wherein the size and functionality of a program component is scaled with the size of available resources of a system to run the computer program.

5. computer program product according to claim 1 wherein the data structure is an XML data structure with modules defined by XML elements.

6. A computer program product according to claim 1 wherein the computer program is arranged to download program components and integrate them as a portion of the browser.

7. A computer program product according to claim 1 wherein the data structure is split by the modules and forwarded to browsers distributed on multiple devices (101).

8. A computer program product according to claim 1 arranged to dispose different capabilities in the form of profiles by loading into the structure a set of components corresponding to a selected profile.

9. A set-top box with a computer program as set forth in claim 1.

10. A mobile telephone with a computer program as set forth in claim 1.

11. A general-purpose computer with a computer program as set forth in claim 1.

12. A method of forming a browser program (103; 200; 300), wherein the program is arranged in a browser structure (200; 300) comprised of program components (201, . . . , 211; 301, . . . , 306);
processing contents arranged in a data structure comprised of modules; and
matching each program component in the browser structure with a respective module in the data structure.
